(19) United States
(12) Patent Application Publication
(10) Pub. No.: US 2011/0061241 A1
(43) Pub. Date: Mar. 17, 2011

(54) PRESSURE ADJUSTABLE KNIFE SET FOR ELECTROMOTIVE HAIR CUTTER

(76) Inventor: Jheng-Mau Jian, Kaoshiung (TW)

(21) Appl. No.: 12/562,126

(22) Filed: Sep. 17, 2009

(51) Int. Cl. B26B 19/06

(52) U.S. Cl. 30/201

(57) ABSTRACT

A pressure adjustable knife set for an electromotive hair cutter comprises: a fixed knife, a movable knife, and a pressure adjust unit; a front edge of the fixed knife having a cutting edge; the fixed knife being formed with a penetrating hole for passing through the adjustable screw of the pressure adjusting unit; a front edge of the movable knife being formed with a cutting edge; a lower side of the movable knife being formed with a supporting leg; the supporting leg being formed with a plurality of heat dissipating holes with a further function of reduction of the friction area of the supporting legs; the movable knife being formed with a penetrating trench; and a fixing plate being installed between the fixed knife and the pressure adjusting unit; an adjustable screw passing through a penetrating hole of the fixed knife, the movable knife and the pressure adjusting unit.

### FIELD OF THE INVENTION

The present invention relates to hair cutters, and particularly to a pressure adjustable knife set for an electromotive hair cutter

### BACKGROUND OF THE INVENTION

The prior art electromotive hair cutter has a fixed knife and a movable knife. The movable knife moves reciprocally along the fixed knife for cutting hairs. The fixed knife has V shape cuts so that only little hairs are cut. Furthermore, the tightness between the fixed knife and the movable knife is related to the smooth of the cutting. If the pressure is too light, the knife is not sharp enough to cut the hair effectively. If the applied pressure is too great, the friction will be too large so that the knife will heat to burn the skin and thus the hair cutter must be shut down for cooling. The cutter is not useful and the knife is worn quickly and thus the lifetime is short. The motor of the cutter has a great burden and thus has a short lifetime.

### SUMMARY OF THE INVENTION

Accordingly, the object of the present invention is to provide a pressure adjustable knife set for an electromotive hair cutter comprising: a fixed knife, a movable knife, and a pressure adjust unit for adjusting pressures between the two knives; a front edge of the fixed knife having a cutting edge; the fixed knife being formed with a penetrating hole for passing through the adjustable screw of the pressure adjusting unit; a front edge of the movable knife being formed with a cutting edge; a lower side of the movable knife being formed with a supporting leg; the supporting leg being formed with a plurality of heat dissipating holes with the functions of heat dissipation and reduction of the friction area of the supporting legs; the movable knife being formed with a long penetrating trench; and a fixing plate being installed between the fixed knife and the pressure adjusting unit; an adjustable screw passing through a penetrating hole of the fixed knife, the movable knife and the pressure adjusting unit. A front edge of the fixed knife 1 has a cutting edge with a plurality of U shape recesses. Each of two ends at a bottom of the long penetrating trench is formed with a heat dissipating notch which is opened at lateral side of the movable knife. A spring circles the adjustable screw between the movable knife and the pressure adjusting unit for tightening the adjustable screw; and the adjustable screw serves to adjust the pressing force of the pressure adjusting unit.

The various objects and advantages of the present invention will be more readily understood from the following detailed description when read in conjunction with the appended drawing.

### BRIEF DESCRIPTION OF THE DRAWINGS

FIG. 1 is an embodiment of the present invention.

FIG. 2 is an assembled perspective view of the present invention.

FIG. 3 is a cross sectional view along line 3-3 of FIG. 2.

FIG. 4 is a cross sectional view along line 4-4 of FIG. 2.

FIG. 5 is a schematic view about the pressure adjustment of the present invention (reduction of pressure between knives).

FIG. 6 is a schematic view about the pressure adjustment of the present invention (increasing of pressure between knives).

FIG. 7 is an elevational view of the present invention.

FIG. 8 is a lateral view of FIG. 7.

FIG. 9 is an upper view of the present invention.

FIG. 10 is an elevational view of the movable knife of the present invention.

FIG. 11 is a right side view of FIG. 10.

FIG. 12 is an elevational view of FIG. 10.

FIG. 13 is an elevational view of second embodiment about the movable knife.

FIG. 14 is a right side view of FIG. 13.

FIG. 15 is an upper view of FIG. 13.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

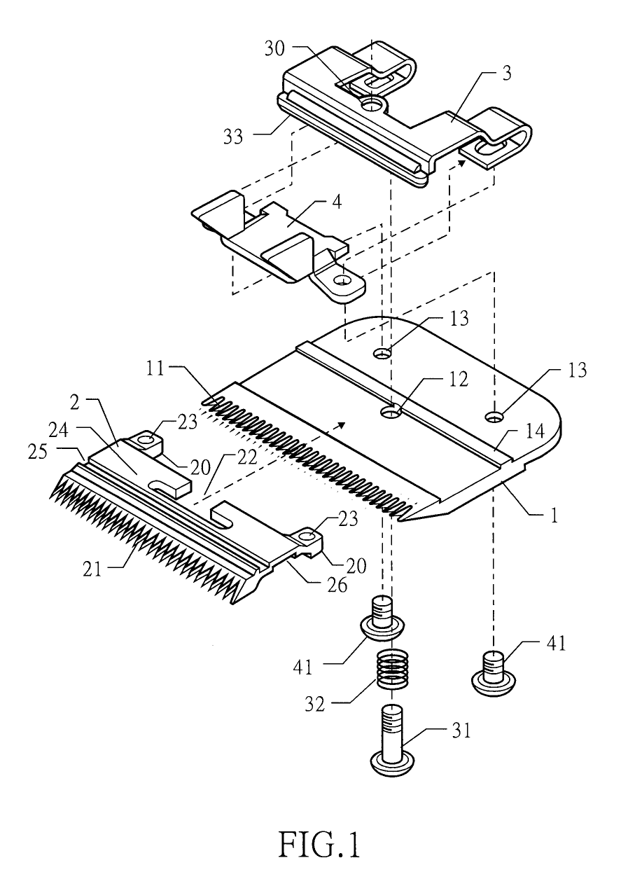

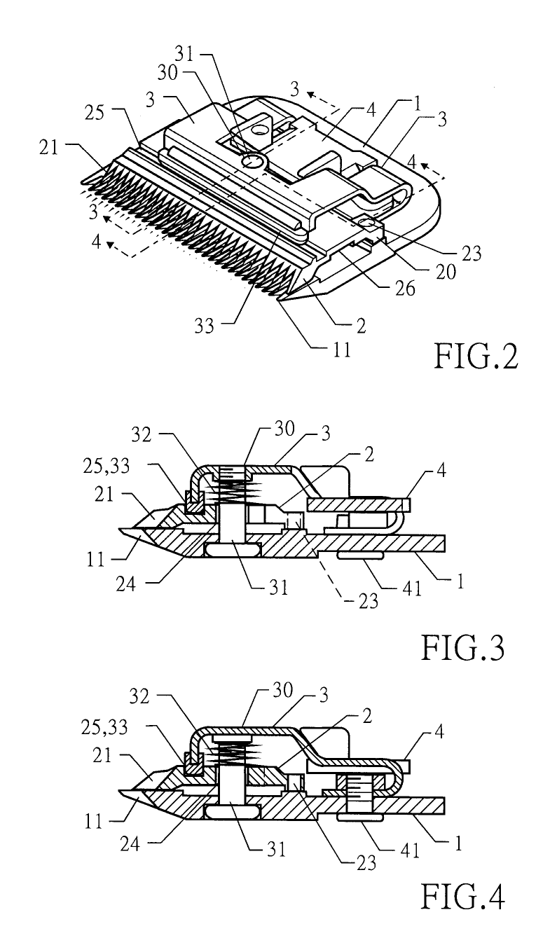

Referring to FIGS. 1 to 4, the pressure adjustable knife set for an electromotive hair cutter according to the present invention is illustrated. The knife set includes a fixed knife 1, a movable knife 2, and a pressure adjust unit 3 for adjusting pressures between the two knives.

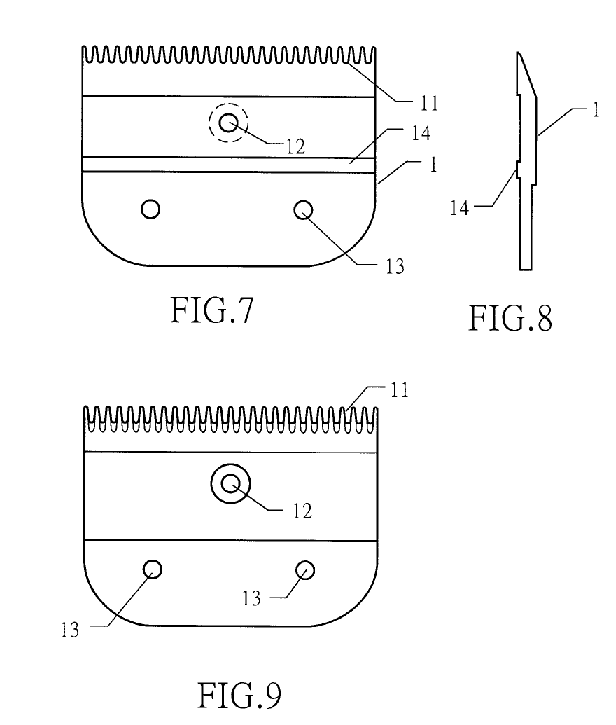

With referring to FIGS. 7 to 9, a front edge of the fixed knife 1 has a cutting edge 11 with a plurality of U shape recesses. The fixed knife 1 is formed with a penetrating hole 12 for passing through the screw 31 of the pressure adjusting unit 3 and two penetrating holes 13 for passing the screws 41 for fixing the fixed knife 1 to a fixing portion of an electromotive hair cutter. An upper side of the fixed knife 1 has a protruding strip 14 for installing the supporting leg 20 of the movable knife 2.

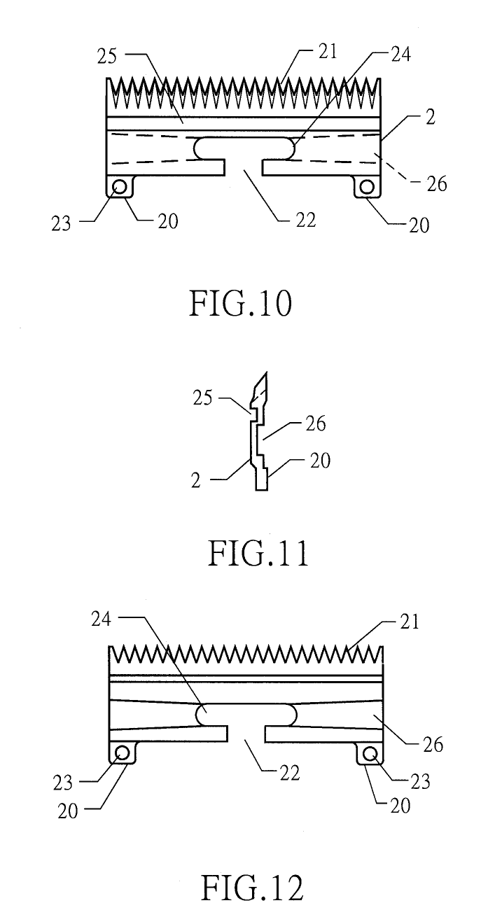

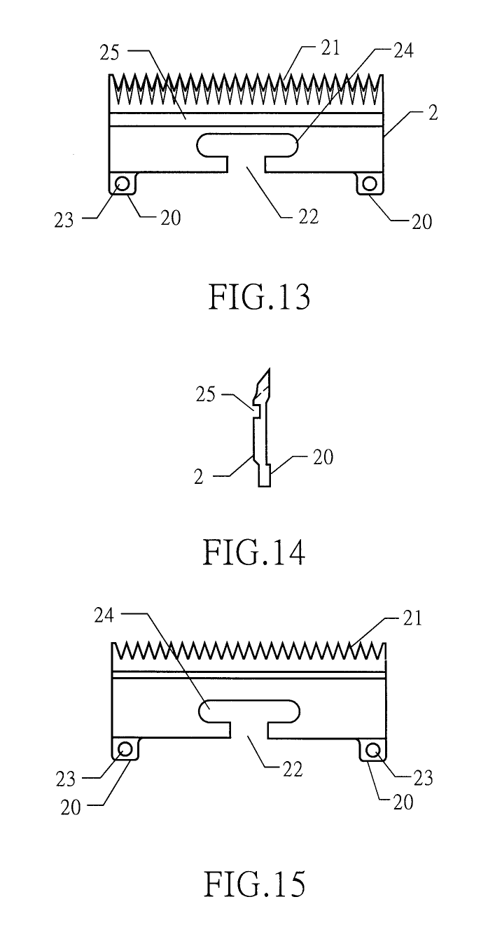

With referring to FIGS. 10 to 12, a front edge of the movable knife 2 is formed with a cutting edge 21 with a plurality of V shape recesses 21 and a plurality of V shape cutting tips. A rear edge of the movable knife 2 is formed with a notch 22. A lower side of the movable knife 2 is formed with supporting leg 20 which can be installed upon the protruding strip 14 of the fixed knife 1. The supporting leg 20 is formed with a plurality of heat dissipating holes 23 with the functions of heat dissipation and reduction of the friction area of the supporting legs 20. The movable knife 2 is formed with a long penetrating trench 24. A rectangular positioning trench 25 is formed between the cutting edge 21 of the movable knife 2 and the long penetrating trench 24 for movably receiving a pressing portion 33 at a front edge of the pressure adjusting unit 3. Each of two ends at a bottom of the long penetrating trench 24 is formed with a heat dissipating notch 26 which is opened at lateral side of the movable knife 2. FIGS. 13 to 15 show the second embodiment of the moveable knife 2 of the present invention. It is illustrated that no notch 26 at two ends of the long penetrating trench 24.

With referring to FIGS. 1 to 4, a fixing plate 4 is installed between the fixed knife 1 and the pressure adjusting unit 3 by using a screw 41 to pass through the pressure adjusting unit 3 and the fixed knife 1 and another screw 41 to pass through the fixing plate 4 and the fixed knife 1. An adjustable screw 31 passes through a penetrating hole 12 of the fixed knife 1, the notch 22 of the movable knife 2 and a screw hole 30 of the pressure adjusting unit 3. A spring 32 circles the adjustable screw 31 between the movable knife 2 and the pressure adjusting unit 3 for tightening the adjustable screw 31. The adjustable screw 31 serves to adjust the pressing force of the pressure adjusting unit 3.

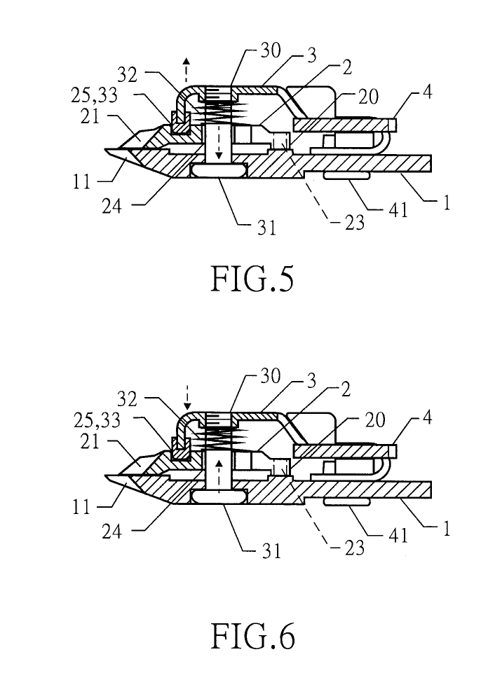

With referring to FIGS. 5 and 6, the adjustment of the adjustable screw 31 will adjust the tighten state between the fixed knife 1 and the movable knife 2. Furthermore, with the U shape cutting edge 11 of the fixed knife 11, a preferably cutting effect is achieved with more hairs entering into the cutting edge.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pressure adjustable knife set for an electromotive hair cutter comprising: a fixed knife, a movable knife, and a pressure adjust unit for adjusting pressures between the two knives;
a front edge of the fixed knife having a cutting edge; the fixed knife being formed with a penetrating hole for passing through the adjustable screw of the pressure adjusting unit;
a front edge of the movable knife being formed with a cutting edge; a lower side of the movable knife being formed with a supporting leg; the supporting leg being formed with a plurality of heat dissipating holes with the functions of heat dissipation and reduction of the friction area of the supporting legs; the movable knife being formed with a long penetrating trench; and
a fixing plate being installed between the fixed knife and the pressure adjusting unit; an adjustable screw passing through a penetrating hole of the fixed knife, the movable knife and the pressure adjusting unit.

2. The pressure adjustable knife set for an electromotive hair cutter as claimed in claim 1, wherein a front edge of the fixed knife has a cutting edge with a plurality of U shape recesses.

3. The pressure adjustable knife set for an electromotive hair cutter as claimed in claim 1, wherein each of two ends at a bottom of the long penetrating trench is formed with a heat dissipating notch which is opened at lateral side of the movable knife.

4. The pressure adjustable knife set for an electromotive hair cutter as claimed in claim 1, wherein a spring circles the adjustable screw between the movable knife and the pressure adjusting unit for tightening the adjustable screw; and the adjustable screw serves to adjust the pressing force of the pressure adjusting unit.
